(19) United States
(12) Patent Application Publication
(10) Pub. No.: US 2018/0284523 A1
(43) Pub. Date: Oct. 4, 2018

(54) DISPLAY DEVICE

(71) Applicant: Japan Display Inc., Minato-ku (JP)

(72) Inventors: Emi HIGANO, Tokyo (JP); Toshiyuki Higano, Tokyo (JP); Shigesumi Araki, Tokyo (JP)

(73) Assignee: Japan Display Inc., Minato-ku (JP)

(21) Appl. No.: 15/938,031

(22) Filed: Mar. 28, 2018

(30) Foreign Application Priority Data
Mar. 28, 2017 (JP) 2017-063057

(51) Int. Cl. G02F 1/1333; G02F 1/1339; G02F 1/1362; G02F 1/1335; G02F 1/1368; G02F 1/1343

(52) U.S. Cl. CPC G02F 1/133305; G02F 1/13394; G02F 1/136286; G02F 1/133512; G02F 1/136227; G02F 1/1368; G02F 1/1337; G02F 1/13439; G02F 2001/13396; G02F 2201/123; G02F 2001/134345; G02F 2001/13685; G02F 1/134309

(57) ABSTRACT

According to one embodiment, a display device comprises first and second flexible substrates, a liquid crystal layer, first and second spacers. The first flexible substrate includes first and second surfaces. The second flexible substrate includes a third surface opposite to the first surface and a fourth surface opposite to the third surface. The liquid crystal layer is disposed between first and third surfaces. The first spacer is disposed on the first surface. The second spacer is disposed on the third surface. One of the first and second spacers has a concave and the other of the first and second spacers has a convex. The tip of the convex contacts the concave.

### CROSS-REFERENCE TO RELATED APPLICATIONS

This application is based upon and claims the benefit of priority from Japanese Patent Application No. 2017-063057, filed Mar. 28, 2017, the entire contents of which are incorporated herein by reference.

### FIELD

Embodiments described herein relate generally to a flexible liquid crystal display device.

### BACKGROUND

Liquid crystal display devices include a pair of substrates aligned and overlapped with each other. On both or one of the substrates, an optical film such as a polarizer is adhered. If one of the substrates is pulled by a device which apples the optical film or a device which peels off a protection film from the substrate before applying the optical film, one of the substrates may be shifted from the other substrate. Furthermore, if adjacent edges of the flexible display device are curved, one of the substrates may be diagonally shifted from the other substrate. The flexible display device includes substrates formed of a flexible material such as a resin. As above described examples, the flexible substrates are bent or extended when being pulled, and thus, a positional shift tends to occur with a weak force as compared to a rigid material substrate such as a glass substrate.

The present application provides a display device which can suppress a positional shift of a pair of substrates.

### BRIEF DESCRIPTION OF THE DRAWINGS

FIG. 1 is a plan view of a schematic structure commonly applied to display devices of the embodiments.

FIG. 2 is a plan view showing a subpixel of FIG. 1 in an enlarged manner.

FIG. 3 is a cross-sectional view taken along line F3-F3 of FIG. 2.

FIG. 4 is a flowchart of an example of a manufacturing method of the display device.

FIG. 5 is a plan view showing a process of peeling off a protection film of FIG. 4.

FIG. 6 is a side view showing a process of adhering an optical film of FIG. 4.

FIG. 7 is a plan view showing F7 of FIG. 2 in an enlarged manner.

FIG. 8 is a cross-sectional view of first and second spacers of the display device of the first embodiment, taken along line F8-F8 of FIG. 7.

FIG. 9 is a plan view schematically showing arrangement density of convexes.

FIG. 10 is a cross-sectional view of first and second spacers of a first variation of the first embodiment.

FIG. 11 is a cross-sectional view of first and second spacers of a second variation of the first embodiment.

FIG. 12 is a cross-sectional view of first and second spacers of a third variation of the first embodiment.

FIG. 13 is a cross-sectional view of first and second spacers of a fourth variation of the first embodiment.

FIG. 14 is a cross-sectional view of first and second spacers of a fifth variation of the first embodiment.

FIG. 15 is a cross-sectional view of first and second spacers of a sixth variation of the first embodiment.

FIG. 16 is a perspective view of a display device having a curved non-display area.

FIG. 17 is a cross-sectional view showing a step of adhering the display device to a cover member.

FIG. 18 is a cross-sectional view showing first and second protrusions of a display device of a second embodiment.

### DETAILED DESCRIPTION

In general, according to one embodiment, a display device comprises a first flexible substrate, a second flexible substrate, a liquid crystal layer, a first spacer, and a second spacer. The first flexible substrate includes a first surface and a second surface opposite to the first surface. The second flexible substrate includes a third surface facing the first surface and a fourth surface opposite to the third surface. The liquid crystal layer is disposed between the first surface and the third surface. The first spacer is disposed on the first surface. The second spacer is disposed on the third surface. One of the first spacer and the second spacer has a concave and the other of the first spacer and the second spacer has a convex. The tip of the convex contacts the concave.

Embodiments will be described hereinafter with reference to the accompanying drawings. Incidentally, the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, and the like of the respective parts are schematically illustrated in the drawings, compared to the actual modes. However, the schematic illustration is merely an example, and adds no restrictions to the interpretation of the invention. Besides, in the specification and drawings, the structural elements having functions, which are identical or similar to the functions of the structural elements described in connection with preceding drawings, are denoted by like reference numerals, and an overlapping detailed description is omitted unless otherwise necessary.

In this specification, the expressions “a includes A, B or C”, “α includes one of A, B and C” and “α includes one selected from the group consisting of A, B and C” does not exclude a case where α includes a plurality of combinations of A to C unless otherwise specified. Further, these expressions do not exclude a case where α includes other elements.

In the following description, the display device is a liquid crystal display device DSP. The display device DSP may be used for a smartphone tablet terminal, mobile phone, personal computer, television, car-equipped device, gaming device, wearable device, and the like.

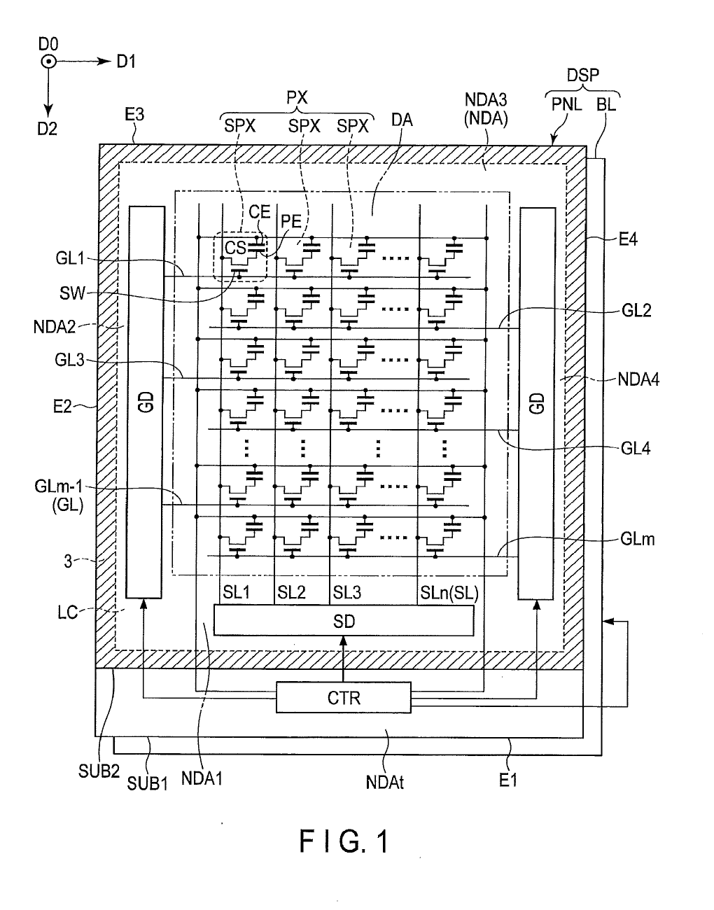

FIG. 1 is a plan view of a schematic structure of the display device DSP commonly applied to the embodiments. As shown in FIG. 1, the display device DSP includes a display panel (liquid crystal cell) PNL including a display surface and a rear surface and an illumination device (backlight) BL which irradiates light onto the rear surface of the display panel PNL.

The display panel PNL displays an image on a display surface by selectively passing the light incident on the rear surface. The display surface of the display panel PNL may be a flat surface or a curved surface. Note that the display panel PNL may be a reflective type display panel which displays an image on a display surface by selectively reflecting the light incident on the display surface of the display panel PNL. If the display panel PNL is of reflective type, the illumination device BL may be omitted. In the following description, viewing the display panel PNL from its display surface to its rear surface is defined as a plan view.

The display panel PNL includes a first substrate (array substrate) SUB1, second substrate (counter substrate) SUB2, sealant 3, liquid crystal layer LC, and control module CTR. The first substrate SUB1 includes first to fourth sides E1, E2, E3, and E4. For example, the first and third sides E1 and E3 are short sides and the second and fourth sides E2 and E4 are long sides.

The second substrate SUB2 faces the first substrate SUB1 in a thickness direction D0 of the display panel PNL. The first substrate SUB1 is formed to be greater than the second substrate SUB2 in, for example, a longitudinal direction of the display panel PNL and includes a terminal area NDAt exposed from the second substrate SUB2. The control module CTR is provided with the terminal area NDAt. Note that the control module CTR may be provided with an external circuit board connected to the terminal area NDAt.

The sealant 3 is formed of an organic material such as acrylic resin or epoxy resin. The sealant 3 corresponds to a hatched part in FIG. 1 and adheres the first substrate SUB1 and the second substrate SUB2 together. The liquid crystal layer LC is disposed between the first substrate SUB1 and the second substrate SUB2 in an inner position than is the sealant 3.

The display panel PNL includes, in a plan view, a display area DA for image display and a non-display area (bezel area) NDA surrounding the display area DA. The display area DA includes a plurality of subpixels SPX in an m×n matrix. For example, a color display pixel PX including three subpixels SPX corresponding red (R), green (G), and blue (B) can be formed. Note that the pixel PX may include a subpixel SPX of different color such as white and may include some subpixels SPX of same color.

The non-display area NDA includes first to fourth non-display areas NDA1, NDA2, NDA3, and NDA4. The non-display area NDA1 is disposed between the display area DA and the first side E1. Similarly, the second non-display area NDA2 is disposed between the display area DA and the second side E2. The third non-display area NDA3 is disposed between the display area DA and the third side E3. The fourth non-display area NDA4 is disposed between the display area DA and the fourth side E4. The first non-display area NDA1 includes the terminal area NDAt.

The first substrate SUB1 includes, in the display area DA, a plurality of scan signal lines GL (GL1, GL2, GL3, . . . GLm+1) and a plurality of video signal lines SL (SL1, SL2, SL3, . . . SLn+1) crossing the scan signal lines GL. The subpixel SPX corresponds to an area defined by two adjacent scan signal lines GL and two adjacent video signal lines SL.

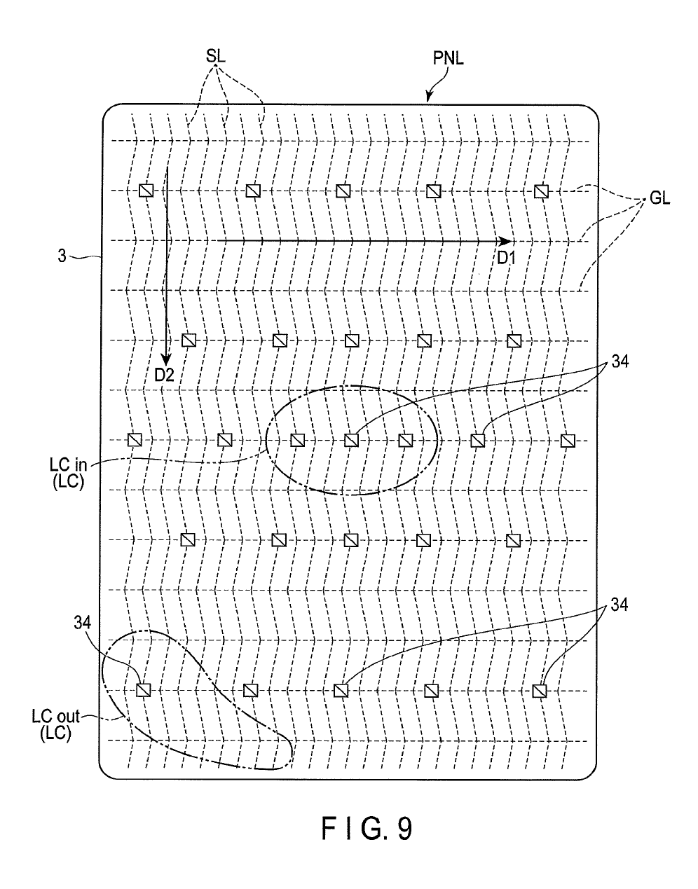

A direction to which the scan signal lines GL extend is defined as first direction D1 and a direction to which the video signal lines SL extend is defined as second direction D2. Note that, in the example of FIG. 1, the video signal lines SL are depicted as straight lines parallel to the second direction D2; however, the video signal lines SL may bend in a zigzag manner and extend in the second direction D2 as in the example of FIG. 9. Although this is not shown, the video signal lines SL may be curved lines meandering about the second direction D2. Similarly, the scan signal lines GL extending in the first direction D1 may bend or meander.

In the example of FIG. 1, the first direction D1 matches the short side direction of the display panel PNL and the second direction D2 matches the long side direction of the display panel PNL. Note that the first and second directions D1 and D2 are not limited to the example of FIG. 1. The first direction D1 may match the long side direction of the display panel PNL and the second direction D2 may match the short side of the display panel PNL, or they may match the different directions.

The first and second directions D1 and D2, and a third direction (for example, crossing direction D3, and third A and third B directions D3A and D3B) and a diagonal direction D4, which are explained later, are all along the display surface of the display panel PNL and orthogonal to the thickness direction D0 of the display panel PNL.

The first substrate SUB1 includes a scan driver GD connected to the scan signal lines GL and a video driver SD connected to the video signal lines SL. The scan driver GD is provided with, for example, the second and fourth non-display areas NDA2 and NDA4. The video driver SD is provided with, for example, the first non-display area NDA1 in an inner position than is the terminal area NDAt. Note that the scan driver GD and the video driver SD may be provided with the control module CTR, or may be provided with an external circuit board connected to the display panel PNL.

The first substrate SUB1 includes, in each subpixel SPX, a switching element SW and a pixel electrode PE. The switching element SW is formed of, for example, a thin film transistor (TFT) and is electrically connected to a scan signal line GL, video signal line SL, and pixel electrode PE. A common electrode CE extends to face the subpixels SPX. The common electrode CE may be provided with the first substrate SUB1 or with the second substrate SUB2.

The control module CTR controls the scan driver GD and the video driver SD. The scan driver GD supplies a scan signal to the scan signal lines GL, and the video driver SD supplies a video signal to the video signal lines SL. When the scan signal is supplied to the scan signal line GL corresponding to the switching element SW, the video signal line SL corresponding to the switching element SW and the pixel electrode PE are electrically connected, and the video signal of the video signal line SL is supplied to the pixel electrode PE. The pixel electrode PE forms a field with the common electrode CE to change the orientation of the liquid crystal molecules of the liquid crystal layer LC. Capacitance CS is formed between the common electrode Ce and the pixel electrode PE, for example.

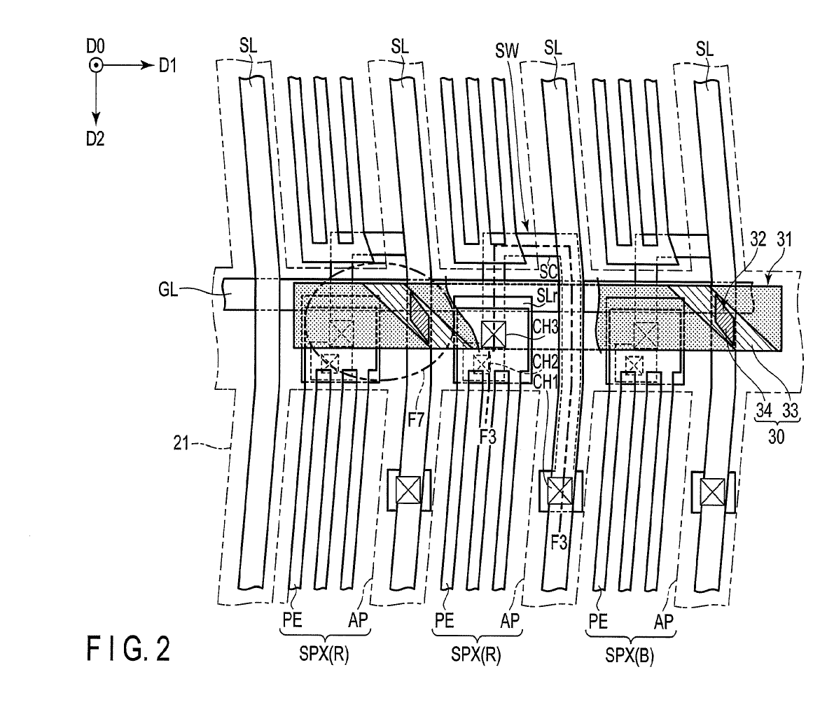

FIG. 2 is a plan view showing the structure of the subpixel SPX of FIG. 1. As shown in FIG. 2, the switching element SW includes a semiconductor layer SC and a relay electrode SLr. The semiconductor layer SC contacts the video signal line SL in a first contact hole CH1 and contacts the relay electrode SLr in a second contact hole CH2.

The semiconductor layer SC extends from the first contact hole CH1 to the scan signal line GL overlapping the video signal line SL, crosses the scan signal line GL, and then, bends in a U-letter shape to extend in the second contact hole CH2. The relay electrode SLr contacts the pixel electrode PE in a third contact hole CH3. In this example, the switching element SW is of double gate type in which the semiconductor layer SC crosses the scan signal lien GL twice; however, the switching element may be of single gate type.

The area depicted with a single-dotted line in FIG. 2 corresponds to a light shielding layer 21 which shields the light. The light shielding layer 21 overlaps, in a plan view, the scan signal line GL, video signal line SL, relay electrode SLr, and semiconductor layer SC. The light shielding layer 21 includes apertures AP in the subpixels SPX. The pixel electrode PE extends in an aperture AP. In the example of FIG. 2, the video signal lines SL extend in the second direction D2 bending in a zigzag manner. The pixel electrode PE includes two slits formed parallel to the video signal line SL; however, no limitation is intended thereby.

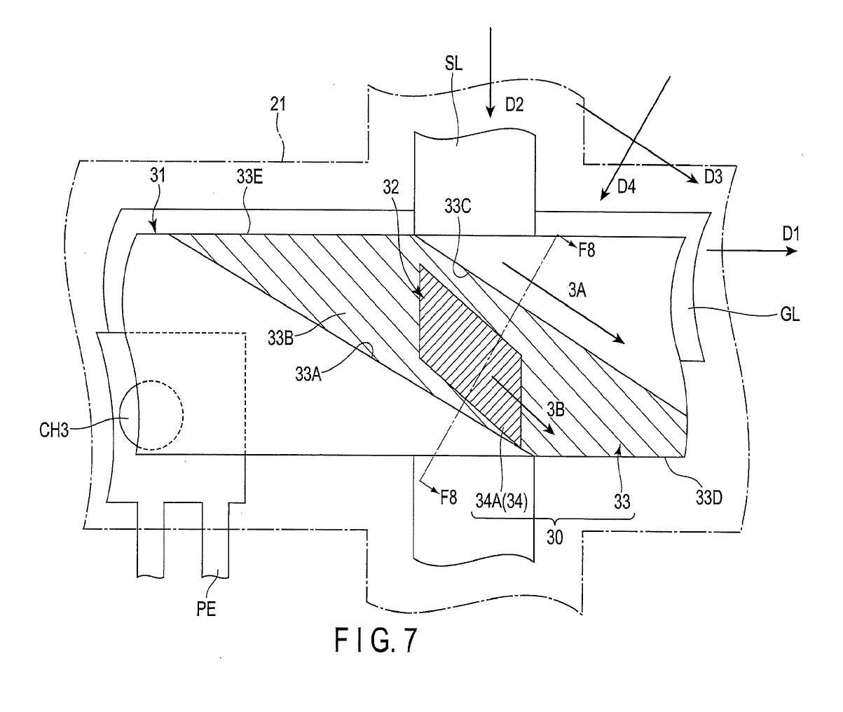

The display device DSP of each embodiment further includes first and second spacers 31 and 32. One of the first and second spacers 31 and 32 includes a concave 33 and the other of the first and second spacers 31 and 32 includes a convex 34, and the concave 33 and the convex 34 form a stopper 30 which controls positional shifting of the first and second substrates SUB1 and SUB2. The first and second spacers 31 and 32 will be described later with reference to FIGS. 7 to 14.

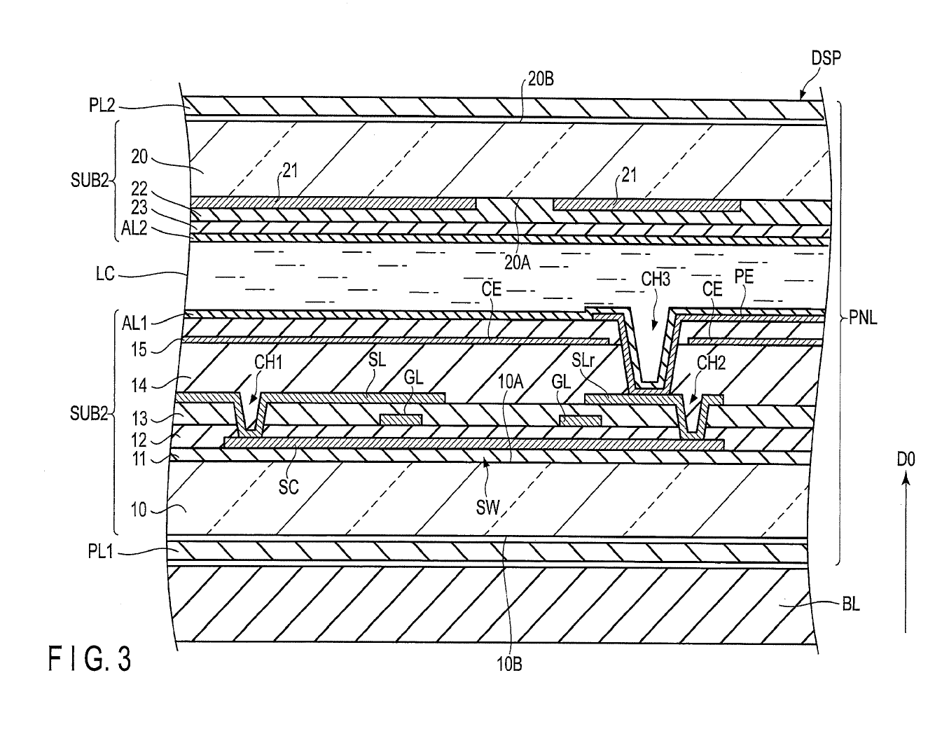

FIG. 3 is a cross-sectional view of the display device DSP, taken along line F3-F3 of FIG. 2. In the example of FIG. 3, the display panel PNL has the structure corresponding to a display mode which mainly uses a transverse field substantially parallel to the display surface. Note that the display panel PNL may have the structure corresponding to a display mode which uses a field vertical with respect to the display surface, or a field diagonal with respect to the display surface, or a combination of these fields.

As described above, the first substrate SUB1 includes the scan signal line GL, video signal line SL, switching element SW, pixel electrode PE, and common electrode CE. In addition thereto, the first substrate SUB1 includes, as shown in FIG. 3, a first flexible substrate 10, first insulating layer 11, second insulating layer 12, third insulating layer 13, fourth insulating layer 14, fifth insulating layer 15, and first alignment film AL1.

The first flexible substrate 10 is, for example, formed of a polyimide resin and is flexible, transmissive, and insulative. The first flexible substrate 10 includes a first surface 10A facing the second flexible substrate 20 and a second surface 105 in the opposite side to the first surface 10A. The first insulating layer 11 covers the first surface 10A of the first flexible substrate 10.

The semiconductor layer SC is formed on the first insulating layer 11. The second insulating layer 12 covers the first insulating layer 11 and the semiconductor layer SC. The scan signal line GL is formed on the second insulating layer 12. The third insulating layer 13 covers the second insulating layer 12 and the scan signal line GL.

The video signal line SL and the relay electrode SLr are formed on the third insulating layer 13. The video signal line SL and the relay electrode SLr are formed in a single process. The fourth insulating layer 14 covers the third insulating layer 13, video signal line SL, and relay electrode SLr. The common electrode CE is formed on the fourth insulating layer 14. The fifth insulating layer 15 covers the fourth insulating layer 14 and the common electrode CE.

The pixel electrode PE is formed on the fifth insulating layer 15. Note that the pixel electrode PE may be formed below the fifth insulating layer 15, and the common electrode CE may be formed above the fifth insulating layer 15. The fifth insulating layer 15 is an example of an interlayer insulating layer which insulates the pixel electrode PE and the common electrode CE. The first alignment film AL1 covers the fifth insulating layer 15 and the pixel electrode PE.

The scan signal line GL and the video signal line SL are formed of, for example, a metal material of single-layered structure or of layered structure. The video signal line SL may be thinner than the scan signal line GL. The relay electrode SLr is formed of the same metal material used for the video signal line SL, for example. The semiconductor layer SC is formed of a low or high temperature polysilicon (LTPS or HIPS). The pixel electrode PE and the common electrode CE are transparent conductive films formed of indium tin oxide (ITO) or indium zinc oxide (IZO).

The first to third and fifth insulating layers 11, 12, 13, and 15 are inorganic insulating layers formed of silicon oxide, silicon nitride, alumina, or the like. The fourth insulating layer 14 is an organic insulating layer formed of a photosensitive resin such as acrylic resin. The fourth insulating layer 14 has a function to flatten the unevenness of the switching element SW, and is formed to be thicker than the first to third and fifth insulating layers 11, 12, 13, and 15 and the first alignment film AL1. The fourth insulating layer 14 may be referred to as an organic flattening film.

The first and second contact holes CH1 and CH2 pass through the second and third insulating layers 12 and 13. The video signal line SL contacts the semiconductor layer SC through the first contact hole CH1. The relay electrode SLr contacts the semiconductor layer SC through the second contact hole CH2. One of the video signal line SL and the relay electrode SLr is a source electrode and the other thereof is a drain electrode.

The third contact hole CH3 passes the fourth and fifth insulating layers 14 and 15. The pixel electrode PE contacts the relay electrode SLr through the third contact hole CH3 and is electrically connected to the semiconductor layer SC. The third contact hole CH3 is an example of the contact hole through which the pixel electrode PE and the transistor (switching element SW) are electrically connected.

The second substrate SUB2 includes, in addition to the light shielding layer 21, the second flexible substrate 20, color filter layer 22, overcoat layer 23, and second alignment film AL2. The second flexible substrate 20 is formed of the same resin material used for the first flexible substrate 10. The second flexible substrate 20 includes a third surface 20A facing the first surface 10A of the first flexible substrate 10 and a fourth surface 20B which is in the opposite side of the third surface 20A.

The light shielding layer 21 is formed in the third surface 20A of the second flexible substrate 20 and covers the non-display area NDA shown in FIG. 1 in a plan view. The color filter layer 22 covers the third surface 20A and the light shielding layer 21. The color filter layer 22 includes colors corresponding to the subpixels SPX. The overcoat layer 23 covers the color filter layer 22. The second alignment film AL2 covers the overcoat layer 23.

The liquid crystal layer LC is disposed between the first and second alignment films AL1 and AL2. The first and second alignment films AL1 and AL2 align liquid crystal molecules of the liquid crystal layer LC while no voltage is applied to the pixel electrode PE. The first and second alignment films AL1 and AL2 are formed of a polyimide resin or the like applied by, for example, ink jet printing or flexography.

On the second surface 10B of the first flexible substrate 10, a first polarizer PL1 is adhered. On the fourth surface 20B of the second flexible substrate 20, a second polarizer PL2 is adhered. Note that, if the illumination device BL which irradiates polarized light is used, the first polarizer PL1 may be omitted.

The first and second polarizer PL1 and PL2 are examples of optical films adhered to the second surface 10B of the first flexible substrate 10 and the fourth surface 20B of the second flexible substrate 20. Note that the optical film is not limited to a polarizer which selectively passes desired polarized light of the incident light. As different examples of the optical films, there are a phase differential plate which compensates a phase difference of a circular polarizer and a light transmissive film which protects the display panel PNL.

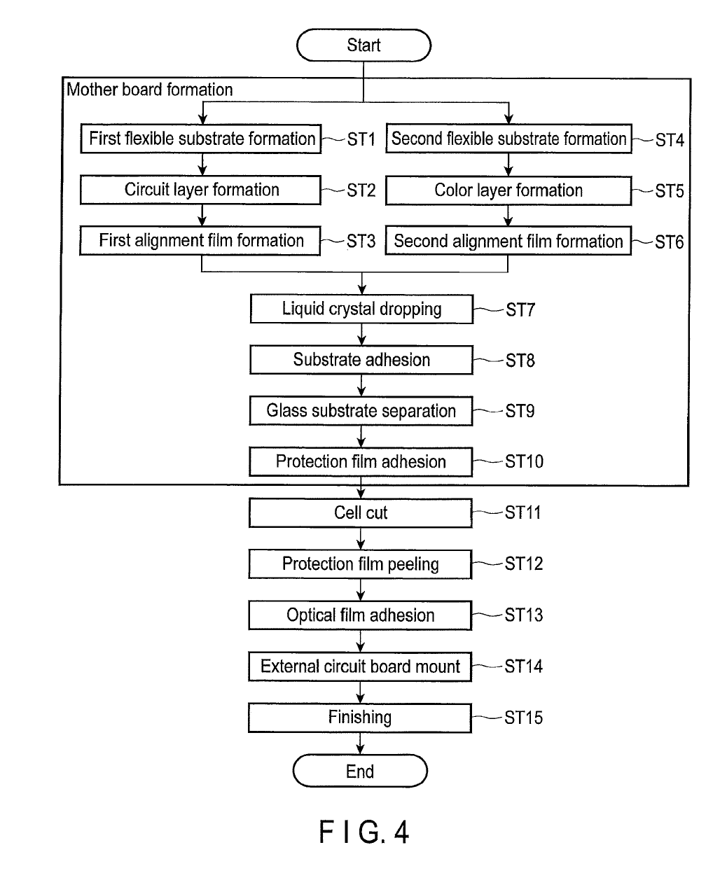

FIG. 4 is a flowchart of an example of a manufacturing method of the display device DSP. The manufacturing method of the display device DSP will be explained with reference to FIG. 4. A first substrate SUB1 is prepared through steps ST1 to ST3. A second substrate SUB2 is prepared through steps ST4 to ST6. A display panel PNL in which the first and second substrates SUB1 and SUB2 are aligned is prepared through steps ST7 to ST11. An optical film is adhered to the display panel PNL through steps ST12 and ST13. The display device DSP is formed through steps ST14 and ST15.

Steps ST1 to ST3 will be explained now. Initially, a material for the first flexible substrate 10 is applied on the upper surface of a rigid glass substrate, and the applied material is cured to form the first flexible substrate 10 (first flexible substrate formation ST1).

Photolithography or the like is repeatedly performed on the first flexible substrate 10 to form a circuit layer in which, for example, the scan signal line GL, scan driver GD, video signal line SL, video driver SD, switching element SW, common electrode CE, pixel electrode PE, first to fifth insulating layers 11, 12, 13, 14, and 15, and first spacer 31 are layered with high positional accuracy (circuit layer formation ST2).

A material of the first alignment film AL1 is applied on the circuit layer, and the applied material is cured to form the first alignment film AL1 (first alignment film formation ST3). A mother board including a plurality of first substrates SUB1 is obtained through steps ST1 to ST3.

Now, steps ST4 to ST6 will be explained. In a similar manner to step ST1, the second flexible substrate 20 is formed (second flexible substrate formation ST4). Photolithography or the like is repeatedly performed on the second flexible substrate 20 to form a color layer in which, for example, the light shielding layer 21, color filter layer 22, overcoat layer 23, and second spacer 32 are layered with high positional accuracy (color layer formation ST5). In a similar manner to step ST3, the second alignment film AL2 is formed (second alignment film formation ST6). Through steps ST4 to ST6, a mother board including a plurality of second substrates SUB2 is obtained.

Now, steps ST7 to ST11 will be explained. A sealant 3 is applied to one of the mother boards, and a liquid crystal material of the liquid crystal layer LC is dropped into the area surrounded by the sealant 3 (liquid crystal drop ST7). Two mother boards are aligned and adhered together, and the sealant 3 is cured (substrate adhesion ST8).

The glass substrate is separated from the second surface 10B of the first flexible substrate 10 (glass substrate separation ST9), and a protection film is adhered to the second surface 10B (protection film adhesion ST10). When laser is irradiated to the second surface 10B of the first flexible substrate 10 through the transmissive glass substrate, the first flexible substrate 10 absorbs the laser and slightly dissolves. Gaps are formed between the first flexible substrate 10 and the glass substrate, and thus, the glass substrate is separated from the first flexible substrate 10.

In a similar manner, the glass substrate is separated from the fourth surface 20B of the second flexible substrate 20, and a protection film is adhered to the fourth surface 20B. The protection film is a film formed of a polyethylene terephthalate resin or the like. The mother boar with the protection film is cut into a plurality of panels (cell cut ST11).

Now, steps ST12 to ST15 will be explained. The protection film is peeled off from the fourth surface 20B of the second flexible substrate 20 (protection film peeling ST12), and the second polarizer PL2 is adhered (optical film adhesion ST13). Similarly, the protection film is peeled off from the second surface 10B of the first flexible substrate 10, and the first polarizer PL1 is adhered.

An external circuit board is mounted in the terminal area NDAt (external circuit board mount ST14). Note that, after the external circuit board is mounted, the protection film may be peeled off and the first polarizer PL1 may be adhered (protection film peeling ST12 and optical film adhesion ST13). By attaching the illumination device BL to the display panel PNL, the display device DSP is formed (finishing ST15). Note that, after step ST 15, a process of curving the edges of the display device DSP, or a step of attaching the display panel PNL to a cover such as a cover glass may be added.

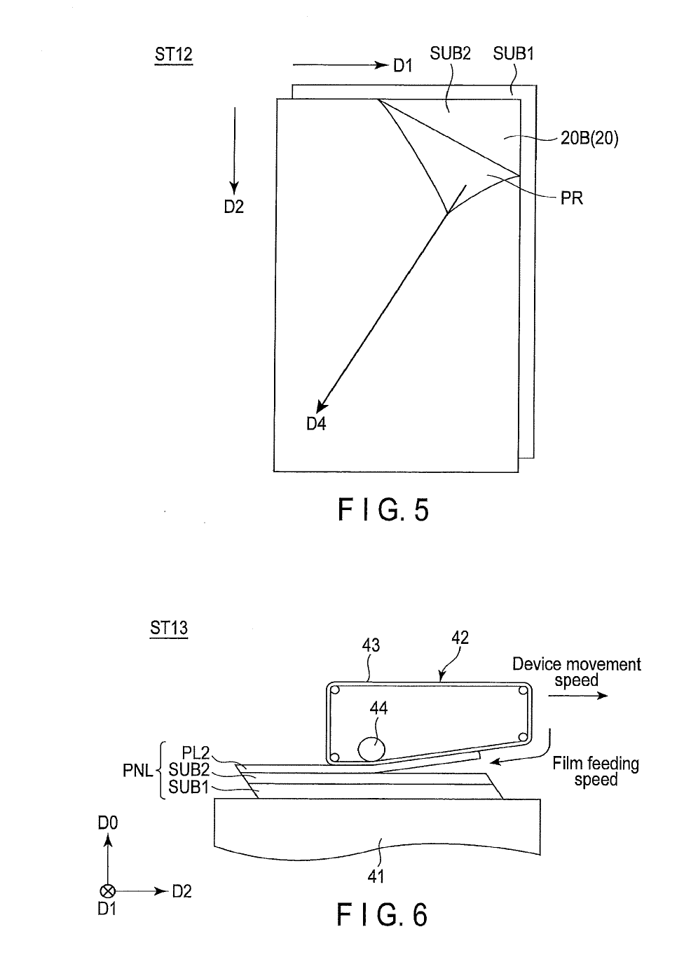

FIG. 5 is a plan view showing an example of step ST12 of FIG. 4. As shown in FIG. 5, a protection film PR is peeled off from the first and second flexible substrates 10 and 20 along a diagonal direction (peeling direction) D4 crossing the first and second directions D1 and D2 (for example, the long side direction and the short side direction of the display panel PNL) in step ST12. At that time, the second substrate SUB2 may be shifted from the first substrate SUB1 in the diagonal direction D4. The diagonal direction D4 is, for example, a direction along the diagonal of the first substrate SUB1 and the second substrate SUB2.

FIG. 6 is a side view showing an example of step ST13 of FIG. 4, in which an optical film is adhered to the display panel PNL fixed to a vacuum suction stage 41 by an adhesion device 42 which conveys the optical film.

The adhesion device 42 includes a lightly adhesive belt 43 which holds the optical film and a main body 44 which rotates the belt 43. The belt 43 is wrapped around the main body 44. The adhesion device 42 moves the main body 44 in the long side direction or the short side direction of the display panel PNL; that is, the first direction D1 or the second direction D2, and rotates the belt 43 such that the optical film such as the second polarizer PL2 is adhered to the substrate such as the second substrate SUB2.

At that time, if the moving speed of the main body 44 and the film feeding speed of the rotating belt 43 are not well synchronized, the second substrate SUB2 which is pulled by the adhesion device 42 may be shifted from the first substrate SUB1 which is fixed by the vacuum suction stage 41.

### First Embodiment

Now, the display device DSP of the first embodiment will be explained with reference to FIGS. 2 and 7 to 9. The display device DSP of the first embodiment includes a stopper 30 which suppresses positional shifting of the first substrate SUB1 and the second substrate SUB2 in step ST12 of FIG. 5 and step ST13 of FIG. 6. The stopper 30 is formed of the concave 33 and the convex 34 of the first and second spacers 31 and 32 of FIG. 2.

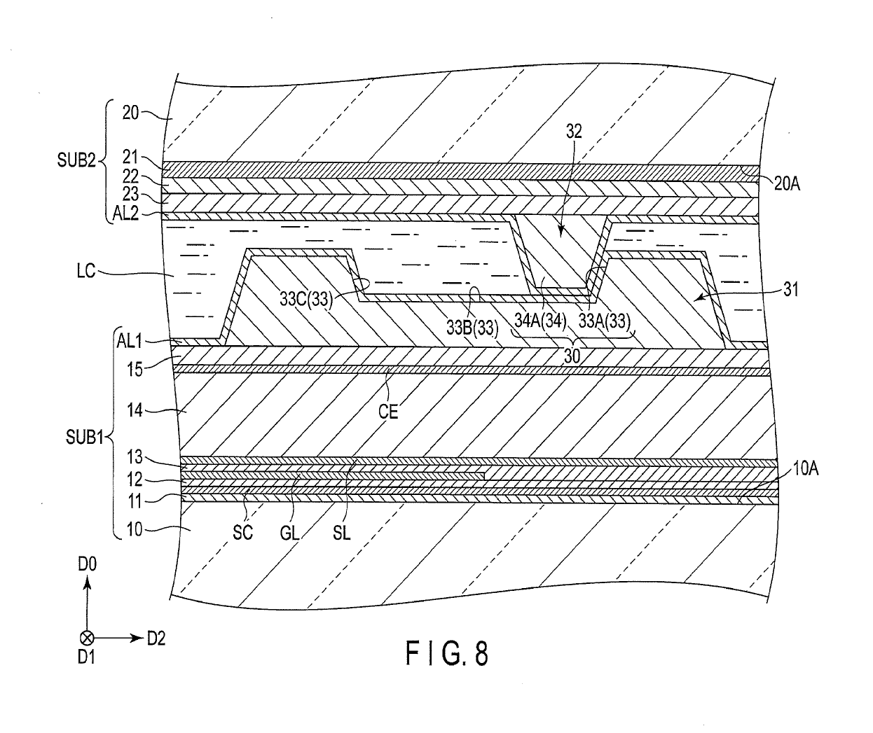

FIG. 7 is a plan view showing F7 of FIG. 2 in an enlarged manner, and FIG. 8 is a cross-sectional view taken along line F8-F8 of FIG. 7. As shown in FIG. 8, the first spacer 31 is disposed in the first surface 10A of the first flexible substrate 10. The second spacer 32 is positioned in the third surface 20A of the second flexible substrate 20 and faces the first spacer 31 in the thickness direction D0 of the display panel PNL.

Note that, as shown in FIG. 8, the scan signal line GL, video signal line SL, switching element SW, common electrode CE, pixel electrode PE, first to fifth insulating layers 11, 12, 13, 14, and 15, and the like may be interposed between the first surface 10A and the first spacer 31 of the first flexible substrate 10. Similarly, the light shielding layer 21, color filter layer 22, overcoat layer 23, and the like may be interposed between the third surface 20A and the second spacer 32 of the second flexible substrate 20.

The first spacer 31 of the first substrate SUB1 includes the concave 33, and the second spacer 32 of the second substrate SUB2 includes the convex 34. Note that, as in a variation which will be described later, the first spacer 31 may include the convex 34, and the second spacer 32 may include the concave 33.

In order to form the concave 33 in the first spacer 31, the thickness of the first spacer 31 is adjusted part by part by a multi-tone process such as a half-tone process, for example. The concave 33 includes, for example, inner surfaces 33A, 33B, and 33C. In the example of FIG. 8, the tip 34A of the convex 34 contacts the inner surface 33A of the concave 33 to prevent the second substrate SUB2 from moving in the diagonal direction D4.

When the second substrate SUB2 moves in the diagonal direction D4 with respect to the first substrate SUB1, the surface of the concave 33 contacting the tip 34A of the convex 34 is given the inner surface 33A or the inner surface 33C, and a gap between the inner surfaces 33A and 33C is given a width of the concave 33. The width of the tip 34A in the diagonal direction D4 is less than the width of the concave 33.

As shown in FIG. 7, the inner surfaces 33A, 33B, and 33C of the concave 33 extend in the third A direction D3A. The concave 33 passes the first spacer 31 in the third A direction 3A and includes open ends 33D and 33E. The tip 34A of the convex 34 extends in the third B direction D3B. The third A and third B directions D3A and D3B are examples of the third direction and substantially match the crossing direction D3 crossing the first and second directions D1 and D2. The crossing direction D3 is, for example, a direction orthogonal to the diagonal direction D4.

In order to secure the tolerance of engagement of the concave 33 and the convex 34, the third A and third B directions D3A and D3B are slightly shifted. Note that, the concave 33 and the convex 34 may be formed such that the third A and third B directions D3A and D3B completely match. An angle formed by the crossing direction D3 and the third A direction D3A is, for example, 30° or less. Similarly, an angle formed by the crossing direction D3 and the third B direction D3B is, for example, 30° or less.

In the first and second directions D1 and D2 and the diagonal direction D4, the inner surfaces 33A and 33C of the concave 33 and the tip 34A of the convex overlap with each other. In other words, the inner surface 33A of the concave 33, tip 34A of the convex 34, and the inner surface 33C of the concave 33 substantially extending in the crossing direction D3 are aligned in a single line in the diagonal direction D4 orthogonal to the crossing direction D3. On the other hand, the concave 33 includes the open ends 33D and 33E, and the inner surfaces 33A and 33C of the concave 33 and the tip 34A of the concave 34 do not overlap in the crossing direction D3.

In step ST12, when the second substrate SUB2 is pulled in the diagonal direction D4 by the protection film PR, the tip 34A of the convex 34 contacts the inner surface 33A or the inner surface 33C as shown in FIG. 7. The movement of the second substrate SUB2 in the diagonal direction D4 is prevented by the stopper 30 formed of the concave 33 and the convex 34.

Similarly, in step ST13, when the second substrate SUB2 is pulled in the first direction D1 or the second direction D2 by the adhesion device 42, the tip 34A of the convex 34 contacts the inner surface 33A or the inner surface 33C of the concave 33 as shown in FIG. 7. The movement of the second substrate SUB2 in the first and second directions D1 and D2 is prevented by the stopper 30 formed of the concave 33 and the convex 34.

The first and second spacers 31 and 32 are disposed to overlap the light shielding layer 21 formed in the display area DA in a plan view. In the examples of FIGS. 2 and 7, the first spacer 31 extends in the first direction D1 and includes a plurality of concaves 33 arranged in the first direction D1. Furthermore, the first spacer 31 extends in the first direction D1 along the scan signal line GL, and in a plan view, overlaps part of the pixel electrode PE and the third contact hole CH3.

The first spacer 31 is, for example, a photosensitive acrylic resin, and thus, has a low adhesion to the fifth insulating layer 15 which is an inorganic insulating layer. In the examples of FIGS. 2 and 7, at least a part of the material used for the first spacer 31 contacts the upper surface of the pixel electrode PE as a transparent conductive film such as ITO which is highly adhesive to the first spacer 31 as compared to the fifth insulating layer 15. Note that the first spacer 31 may contact the transparent conductive film which is not electrically connected to the pixel electrode. Furthermore, at least a part of the material used for the first spacer 31 is positioned inside the third contact hole CH3 covered with the transparent conductive film which is the pixel electrode PE or the like. The material used for the first spacer 31 positioned inside the third contact hole CH3 protects the transparent conductive film.

Note that, in a structure where the pixel electrode PE is formed below the fifth insulating layer 15 and the common electrode CE is formed above the fifth insulating layer 15, at least a part of the material used for the first protrusion 51 contacts the upper surface of the common electrode CE which is a transparent conductive film. In a plan view, when a part of the bottom surface of the first protrusion 51 overlaps with the transparent conductive film, the first protrusion 51 can be tightly adhered to the first substrate SUB1.

FIG. 9 is a plan view schematically showing the arrangement density of the convex 34. In steps ST12 and ST13, in the center LCin of the liquid crystal layer LC which is further apart from the sealant 3 as compared to the periphery LCout of the liquid crystal layer LC fixed to the sealant 3, the second substrate SUB2 tends to be easily shifted from the first substrate SUB1. To prevent positional shifting, the arrangement density of the convex 34 is, preferably, set higher in the center LCin of the liquid crystal layer LC than is in the periphery LCout of the liquid crystal layer LC as shown in FIG. 9.

The display device DSP of the first embodiment structured as above includes the first spacer 31 of the first substrate SUB1 and the second spacer 32 of the second substrate SUB2, and one of the first and second spacers 31 and 32 includes the concave 33 and the other of the first and second spacers 31 and 32 includes the convex 34. The inner surfaces 33A and 33C of the concave 33 and the tip 34A of the convex 34 extend in the crossing direction D3 crossing the first and second directions D1 and D2 and the diagonal direction D4.

Between the first and second substrates SUB1 and SUB2, if one substrate is pulled in the first and second directions D1 and D2 and the diagonal direction D4 with respect to the other substrate, the tip 34A of the convex 34 contacts the inner surface 33A or 33C of the concave 33 and the movement of the other substrate is prevented as shown in FIG. 7. In the first embodiment, the stopper 30 formed of the concave 33 and the convex 34 prevents positional shifting of the first and second substrates SUB1 and SUB2.

Furthermore, in the first embodiment, the concave 33 passes through the first spacer 31 in the crossing direction D3. Since the concave 33 includes the open ends 33D and 33E, the tolerance of engagement of the concave 33 and convex 34 in the crossing direction D3 can be secured greatly. In the example of FIG. 7, the third B direction D3B in which the tip 34A of the convex 34 extends is slightly shifted from the third A direction D3A in which the inner surfaces 33A and 33C of the concave 33. In such a structure of the first embodiment, the tolerance of engagement of the concave 33 and the convex 34 can further be secured greatly.

### [Variations]

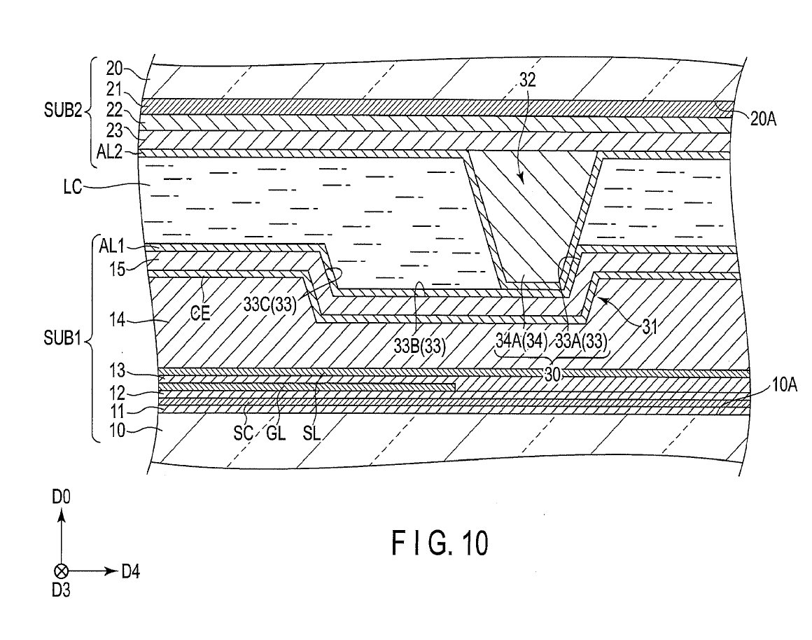

Now, the first and second spacers 31 and 32 of variations of the first embodiment will be explained with reference to FIGS. 10 to 17. Note that, same or similar structures as in the first embodiment are referred to by the same reference numbers in the following description, and explanation considered redundant will be omitted. The other structures are the same as in the first embodiment.

FIG. 10 is a cross-sectional view of the first and second spacers 31 and 32 of a first variation of the first embodiment. In the first variation, the concave 33 is formed in the fourth insulating layer 14, and a part of the fourth insulating layer 14 is formed as the first spacer 31. In these respects, the first variation differs from the first embodiment.

In order to form the concave 33 in the fourth insulating layer 14, the thickness of the fourth insulating layer 14 is adjusted part by part by a multi-tone process such as a half-tone process, for example. The thickness of the fourth insulating layer 14 in a part where a multi-tone process is not performed is, for example, 3 μm. The thickness of the fourth insulating layer 14 in a part where a half-tone process is performed is, for example, 1.5 μm.

According to the first variation, positional shifting of the first and second substrates SUB1 and SUB2 can be suppressed as in the first embodiment. Furthermore, in the first variation, a step of layering the first spacer 31 can be omitted and step ST2 can be simplified. Furthermore, a material of low adhesion is not layered on the fifth insulating layer 15, and thus, the first spacer 31 is not required to be disposed to overlap the transparent conductive film such as the pixel electrode PE, and the freedom of design of the first substrate SUB1 can be increased.

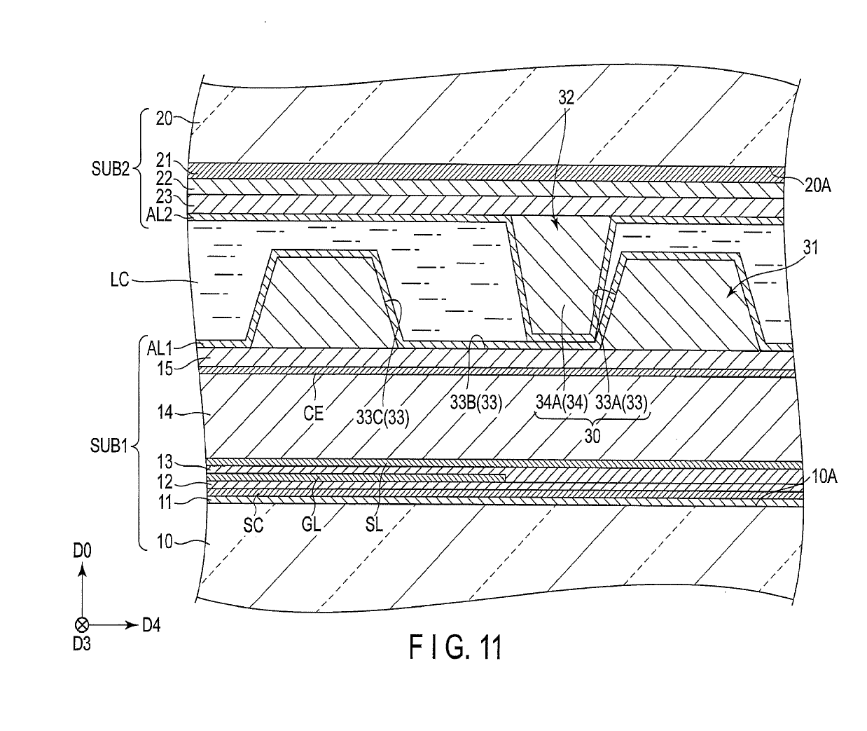

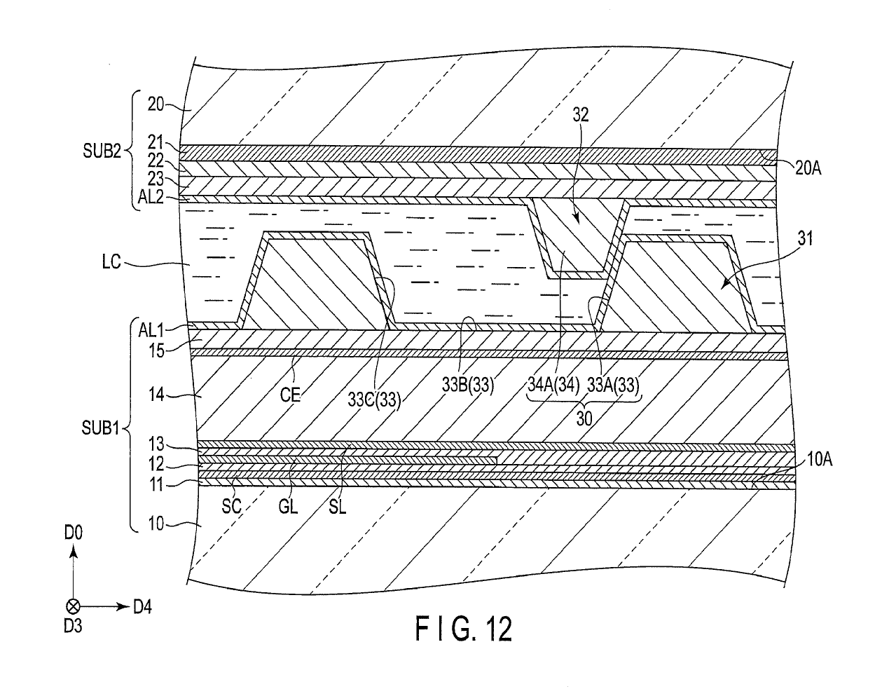

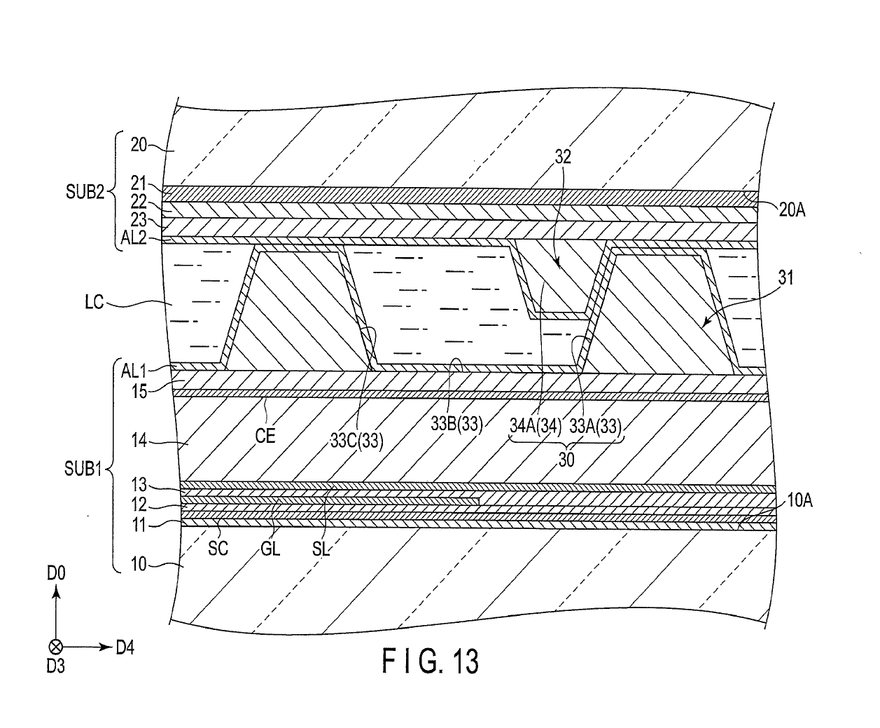

FIG. 11 is a cross-sectional view of a second variation of the first embodiment, FIG. 12 is a cross-sectional view of a third variation of the first embodiment, and FIG. 13 is a cross-sectional view of a fourth variation of the first embodiment. The second to fourth variations include the concave 33 formed in the first spacer 31 by a full-tone process. In this respect, the second to fourth variations differ from the first embodiment. Furthermore, the height of the second spacer 32 differs between the second and third variations. The height of the first spacer 31 differs between the third and fourth variations.

According to the second to fourth variations, positional shifting of the first and second substrates SUB1 and SUB2 in steps ST12 and ST13 can be suppressed as in the first embodiment. In addition, a multi-tone process such as a half-tone process is not required, and thus, step ST2 can be simplified.

In the second variation, the second spacer 32 has a height which is substantially the same as a gap between the first and second substrates SUB1 and SUB2 (cell gap). In the second variation, a gap between the first and second substrates SUB1 and SUB2 can be maintained by the second spacer 32 supporting the second substrate SUB2 even if the display surface of the display panel PNL is pressed by a finger.

In the third variation, the second spacer 32 has a height which is less than a gap between the first and second substrates SUB1 and SUB2. In the third variation, scratch on the first alignment film AL1 by the second spacer 32 can be prevented. For example, if the first and second spacers 31 and 32 are higher than a half of the gap between the first and second substrates SUB1 and SUB2, the stopper 30 can be formed by bringing the inner surfaces 33A and 33C of the concave 33 and the tip 34A of the convex 34 into contact. In the third variation, the first spacer 31 is not formed integrally, but in this case, two projections functioning as walls form a first spacer 31.

In the fourth variation, the first spacer 32 has a height which is substantially the same as a gap between the first and second substrates SUB1 and SUB2. In the fourth variation, a gap between the first and second substrates SUB1 and SUB2 can be maintained by the first spacer 31 supporting the second substrate SUB2 even if the display surface of the display panel PNL is pressed by a finger. Note that, if the first spacer 31 is enlarged, the light shielding layer 21 must be enlarged as well. If the light shielding layer 21 is enlarged, the aperture ratio decreases, and in consideration of the aperture ratio, the second variation is preferred to the fourth variation.

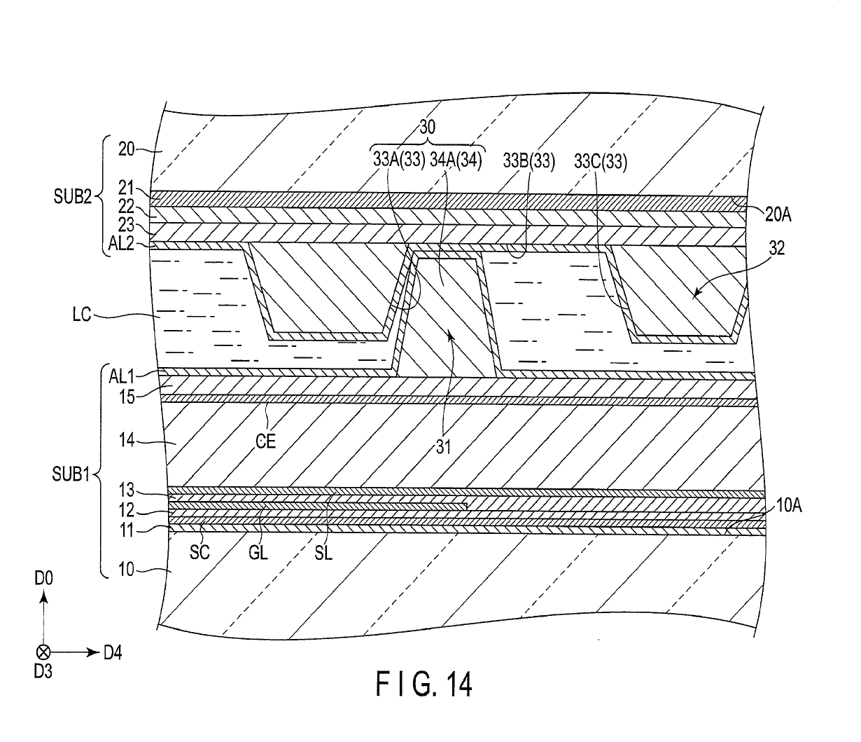

FIG. 14 is a cross-sectional view of the first and second spacers 31 and 32 of the fifth variation of the first embodiment. In the fifth variation, the first spacer 31 includes the convex 34 and the second spacer 32 includes the concave 33, and in this respect, the fifth variation differs from the first embodiment. In the fifth variation, positional shifting of the first and second substrates SUB1 and SUB2 in steps ST12 and ST13 can be suppressed as in the first embodiment.

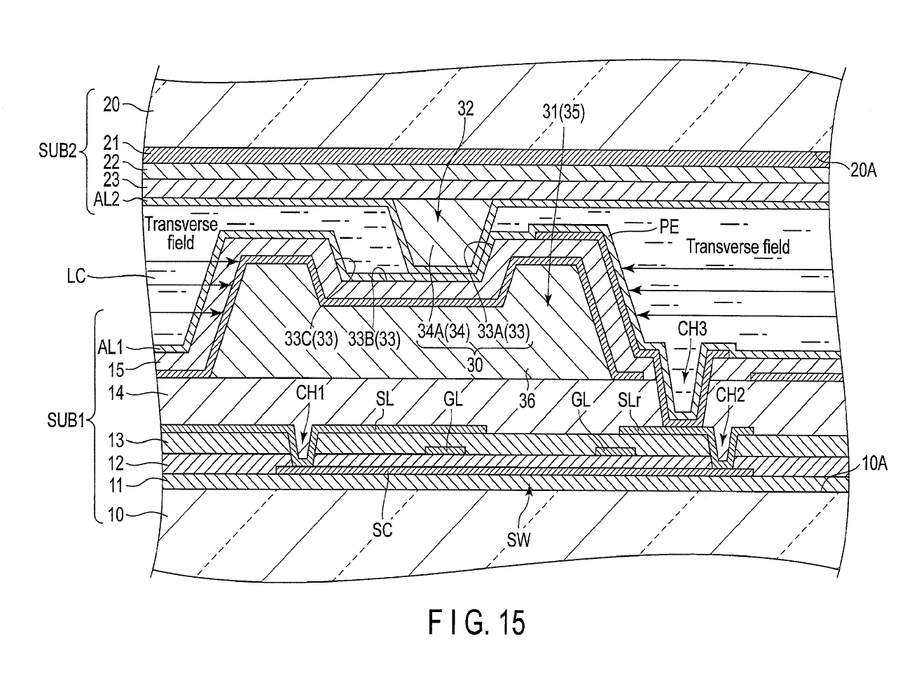

FIG. 15 is a cross-sectional view of the first and second spacers 31 and 32 of the sixth variation of the first embodiment. The display panel PNL of FIG. 15 includes a wall electrode 35. The wall electrode 35 includes a wall 36 projecting inwardly in the liquid crystal layer LC and the common electrode CE and the pixel electrode PE formed in the wall surface of the wall 36, and can generate a transverse field which is substantially parallel to the first substrate SUB1 between adjacent wall electrodes 35. The sixth variation includes the firs spacer 31 as a part of the wall electrode 35, and differs from the first embodiment in this respect.

The display device DSP with the wall electrode 35 can uniform the transmissivity of the liquid crystal layer LC by forming the transverse field applied to the liquid crystal layer LC to be substantially parallel to the first substrate SUB1. With the display device DSP of the sixth variation, positional shifting of the first and second substrates SUB1 and SUB2 in steps ST12 and ST13 can be suppressed as in the first embodiment. Furthermore, since a part of the wall electrode 35 is used as the first spacer 31, an additional step of forming the first spacer 31 is not required.

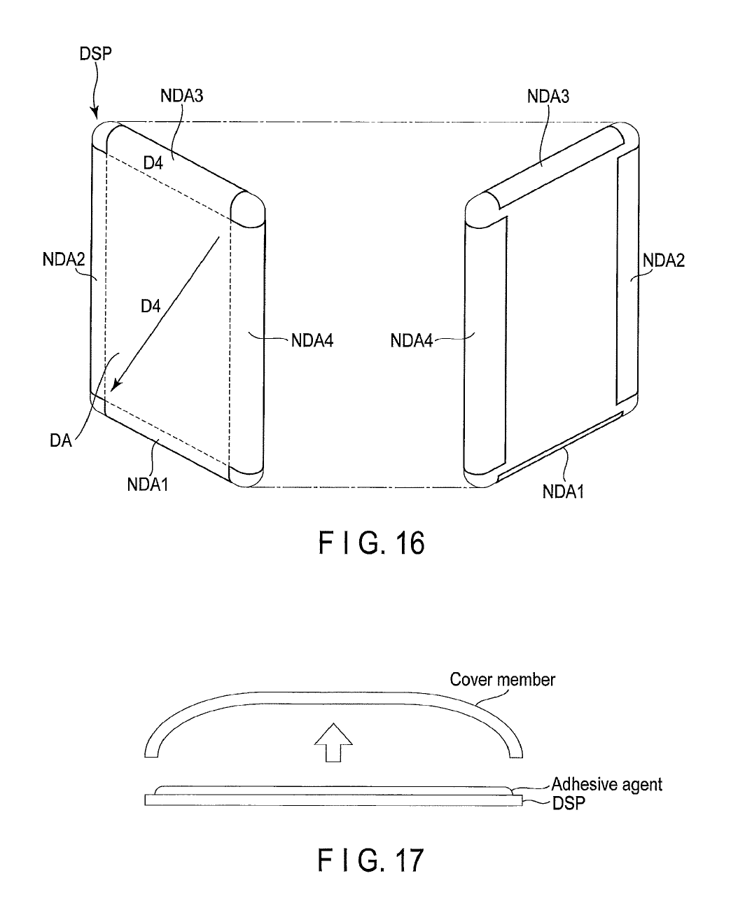

Furthermore, as shown in FIG. 16, edges of the first to fourth display areas NDA1, NDA2, NDA3, and NDA4 of FIG. 1 may be curved. In that case, the second substrate SUB2 may be moved in the diagonal direction D4 with respect to the first substrate SUB1 in the proximity of the edges of the first to fourth display areas NDA1, NDA2, NDA3, and NDA4.

As shown in FIG. 17, the display device DSP may be adhered to a cover member such as a cover glass after step ST15. In that case, the second substrate SUB2 may be moved in the diagonal direction D4 with respect to the first substrate SUB1. However, with the first and second spacers 31 and 32 as in the present embodiment, such a problem can be solved.

### Second Embodiment

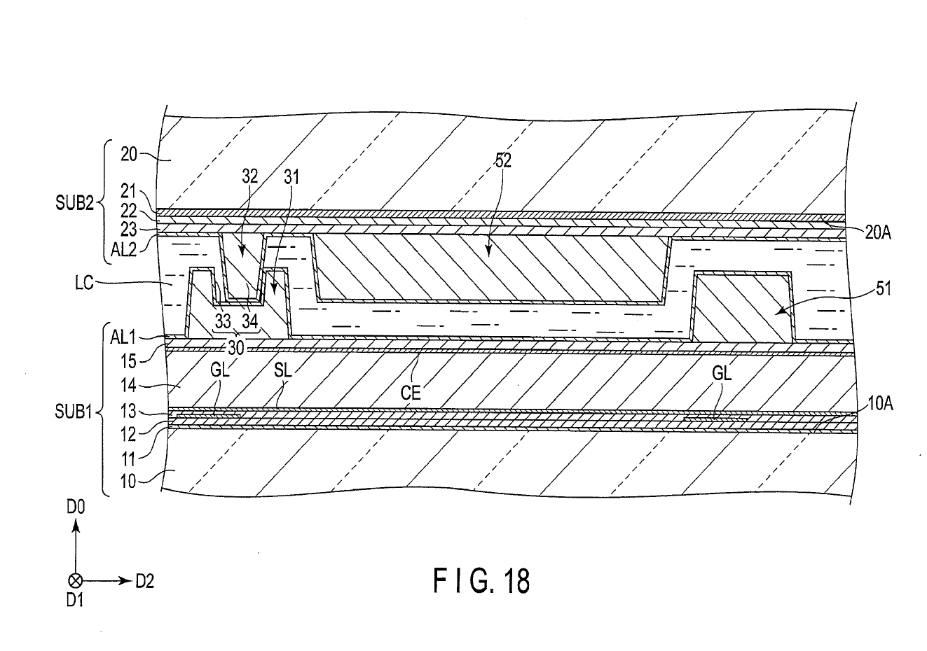

Now, the second embodiment will be explained with reference to FIG. 18. The display device DSP of the second embodiment further includes projections provided with the first surface 10A of the first flexible substrate 10 and/or the third surface 20A of the second flexible substrate 20, and the second embodiment differs from the first embodiment in this respect. Note that the first and second spacers 31 and 32 to be combined with the projections may be structured as in the first embodiment or any of the variations thereof.

FIG. 18 shows an example where a first protrusion 51 is disposed in the first surface 10A of the first flexible substrate 10 and a second protrusion 52 is disposed in the third surface 20A of the second flexible substrate 20. Note that, as shown in FIG. 18, the scan signal line GL, video signal line SL, switching element SW, common electrode CE, pixel electrode PE, first to fifth insulating layers 11, 12, 13, 14, and 15, and the like may be interposed between the first surface 10A and the first protrusion 51 of the first flexible substrate 10. Similarly, the light shielding layer 21, color filter layer 22, overcoat layer 23, and the like may be interposed between the third surface 20A and the second protrusion 52 of the second flexible substrate 20.

The first protrusion 51 is, for example, formed in the layer where the first spacer 31 is formed, and the first protrusion 51 and the first spacer 31 can be formed in the same process. On the other hand, the first protrusion 51 does not face the second spacer 32 and does not contact the second spacer 32, and in this respect, the first protrusion 51 differs from the first spacer 31.

Similarly, in the example of FIG. 18, the second protrusion 52 is formed in the layer where the second spacer 32 is formed, and the second protrusion 52 and the second spacer 32 can be formed in the same process. On the other hand, the second protrusion 52 does not face the first spacer 31 and does not contact the first spacer 31, and in this respect, the second protrusion 52 differs from the second spacer 32.

That is, the first and second protrusions 51 and 52 are not members to suppress positional shifting of the first and second substrates SUB1 and SUB2 or to maintain a gap between the first and second substrates SUB1 and SUB2. In the example of FIG. 18, the first protrusion 51 extends along the scan signal line GL. Note that the first protrusion 51 may extend in a direction crossing the scan signal line GL. In the example of FIG. 18, the first protrusion 51 extends parallel to the first spacer 31. The length of the long side of the first protrusion 51 is greater than the length of the long side of the first spacer 31. Furthermore, height H1 of the first protrusion 51 is, preferably, greater than a half of the value of the thickness H0 of the liquid crystal layer LC.

Similarly, the second protrusion 52 extends along the video signal line SL. Note that the second protrusion 52 may extend in a direction crossing the video signal line SL. The length of the long side of the second protrusion 52 is greater than the length of the long side of the second spacer 32.

In step ST13 of FIG. 6, the first and second substrates SUB1 and SUB2 and the optical films such as first and second polarizers PL1 and PL2 are adhered by pressing the optical films to the first and second substrates SUB1 and SUB2 by the adhesion device 42 to release bubbles or the like therebetween. For example, when the adhesion device 42 pressing the optical films moves from the first side E1 to the third side E3, the liquid crystal material of the liquid crystal layer LC sealed between the first and second substrates SUB1 and SUB2 is pushed out from the first side E1 to the third side E3. If the adhesion device 42 moves rapidly, the liquid crystal material moves rapidly in the above direction, and thus, the sealant 3 surrounding the liquid crystal layer LC may be damaged.

Furthermore, the flexible display device DSP includes the first and second flexible substrates 10 and 20 which are formed of a flexible material. The first and second flexible substrates 10 and 20 are deformed with a weak force as compared to a rigid material such as a glass substrate. In the flexible display device DSP, the momentum of the liquid crystal material toward the sealant 3 is increased by the deformation of the first and second flexible substrates 10 and 20 in step ST13. With the second embodiment, the momentum of the liquid crystal material flowing to the sealant 3 can be eased by the first and second protrusions 51 and 52 extending in the first direction D1 or the second direction D2, and thus, the damage to the sealant 3 can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first flexible substrate including a first surface and a second surface opposite to the first surface;
a second flexible substrate including a third surface opposite to the first surface and a fourth surface opposite to the third surface;
a liquid crystal layer between the first surface and the third surface;
a first spacer on the first surface; and
a second spacer on the third surface, wherein
one of the first spacer and the second spacer has a concave and the other of the first spacer and the second spacer has a convex, and
the tip of the convex contacts the concave.

2. The display device of claim 1, further comprising:
a plurality of scan signal lines extending in a first direction;
a plurality of video signal lines extending in a second direction crossing the first direction; and
a light shielding layer overlapping the scan signal lines and the video signal lines in a plan view, wherein
the first spacer and the second spacer overlap the light shielding layer in a plan view.

3. The display device of claim 1, further comprising:
a plurality of scan signal lines extending in a first direction; and
a plurality of video signal lines extending in a second direction crossing the first direction, wherein
the inner surface of the concave and the tip of the convex extend in a third direction crossing the first direction and the second direction.

4. The display device of claim 2, further comprising:
a plurality of first spacers including the first spacer,
wherein the first spacers extend in the first direction and are arranged in the first direction.

5. The display device of claim 3, further comprising:
a plurality of first spacers including the first spacer,
wherein the first spacers extend in the first direction and are arranged in the first direction.

6. The display device of claim 1, further comprising:
a subpixel disposed on the first surface;
a pixel electrode in the subpixel; and
a transistor electrically connected to the pixel electrode via a contact hole, wherein
at least part of a material of the first spacer is disposed inside the contact hole.

7. The display device of claim 2, further comprising:
a subpixel disposed on the first surface;
a pixel electrode in the subpixel; and
a transistor electrically connected to the pixel electrode via a contact hole, wherein
at least part of a material of the first spacer is disposed inside the contact hole.

8. The display device of claim 3, further comprising:
a subpixel disposed on the first surface;
a pixel electrode in the subpixel; and
a transistor electrically connected to the pixel electrode via a contact hole, wherein
at least part of a material of the first spacer is disposed inside the contact hole.

9. The display device of claim 4, further comprising:
a subpixel disposed on the first surface;
a pixel electrode in the subpixel; and
a transistor electrically connected to the pixel electrode via a contact hole, wherein
at least part of a material of the first spacer is disposed inside the contact hole.

10. The display device of claim 5, further comprising:
a subpixel disposed on the first surface;
a pixel electrode in the subpixel; and
a transistor electrically connected to the pixel electrode via a contact hole, wherein
at least part of a material of the first spacer is disposed inside the contact hole.

11. The display device of claim 1, further comprising:
a subpixel disposed on the first surface; and
a pixel electrode in the subpixel, wherein
the pixel electrode is formed of a transparent conductive film, and the first spacer contacts an upper surface of the transparent conductive film.

12. The display device of claim 2, further comprising:
a subpixel disposed on the first surface; and
a pixel electrode in the subpixel, wherein
the pixel electrode is formed of a transparent conductive film, and the first spacer contacts an upper surface of the transparent conductive film.

13. The display device of claim 3, further comprising:
a subpixel disposed on the first surface; and
a pixel electrode in the subpixel, wherein
the pixel electrode is formed of a transparent conductive film, and the first spacer contacts an upper surface of the transparent conductive film.

14. The display device of claim 1, further comprising:
a plurality of convexes including the convex, wherein
an arrangement density of the convexes is greater in a center of the liquid crystal layer than is in a periphery of the liquid crystal layer.

15. The display device of claim 2, further comprising:
a plurality of convexes including the convex, wherein
an arrangement density of the convexes is greater in a center of the liquid crystal layer than is in a periphery of the liquid crystal layer.

16. The display device of claim 3, further comprising:
a plurality of convexes including the convex, wherein
an arrangement density of the convexes is greater in a center of the liquid crystal layer than is in a periphery of the liquid crystal layer.

17. The display device of claim 4, further comprising:
a plurality of convexes including the convex, wherein
an arrangement density of the convexes is greater in a center of the liquid crystal layer than is in a periphery of the liquid crystal layer.

18. The display device of claim 5, further comprising:
a plurality of convexes including the convex, wherein
an arrangement density of the convexes is greater in a center of the liquid crystal layer than is in a periphery of the liquid crystal layer.

19. The display device of claim 1, further comprising:
a first protrusion on the first surface, wherein
the first protrusion includes a long side which is greater in length than a long side of the first spacer in a plan view, and the first protrusion does not face the second spacer.

20. The display device of claim 1, further comprising:
a second protrusion on the third surface, wherein
the second protrusion includes a long side which is greater in length than a long side of the second spacer in a plan view, and the second protrusion does not face the first spacer.
